(19) United States
(12) Patent Application Publication
(10) Pub. No.: US 2025/0243038 A1
(43) Pub. Date: Jul. 31, 2025

(54) WORKING MACHINE, IN PARTICULAR CRANE, WITH MOTOR BRAKE

(71) Applicant: Liebherr-Werk Ehingen GmbH, Ehingen/Donau (DE)

(72) Inventors: Daniel RÖSSNER, Bellenberg (DE); Thomas LEMKE, Erbach (DE); Matthias STROEBELE, Oggelsbeuren (DE)

(21) Appl. No.: 19/015,170

(22) Filed: Jan. 9, 2025

(30) Foreign Application Priority Data
Jan. 26, 2024 (DE) 10 2024 102 242.6

(51) Int. Cl. B66C 13/48; B66C 13/20; B66C 23/90

(52) U.S. Cl. CPC B66C 13/48; B66C 13/20; B66C 23/905

(57) ABSTRACT

The disclosure relates to a work machine, in particular crane, comprising a cable winch, by means of which a cable can be wound up for lifting a load and unwound for lowering the load, a motor, by means of which the cable winch can be driven, and a controller, by means of which the motor can be controlled, wherein the motor comprises a braking device for generating a braking torque counteracting an externally generated torque. According to the disclosure, when the load is lowered as a function of a predetermined target braking torque and a braking torque that can be provided by the motor, the controller is configured to control the braking device and to control the motor in such a way that the load is lowered at a predetermined and, in particular, constant speed. The disclosure also relates to a method for lowering a load by means of a work machine according to the disclosure and to a corresponding computer program product.

### CROSS REFERENCE TO RELATED APPLICATION

The present application claims priority to German Patent Application No. 10 2024 102 242.6 filed on Jan. 26, 2024. The entire contents of the above-listed application are hereby incorporated by reference for all purposes.

### TECHNICAL FIELD

The present disclosure relates to a work machine and to a method for lowering a load by means of such a work machine, as well as to a corresponding computer program product.

### BACKGROUND

On many work machines, loads are lifted using motorized cable winches. This includes moving heavy machine components such as booms or bracing frames, for example by means of cable winches of the bracing cabling or adjusting winches (machine's own loads), or lifting objects to be moved via the work machines by means of hoist rope winches (external loads). The load is usually lowered by unwinding the cable connected to the load through the cable winch. To prevent the load from lowering uncontrollably and with excessive kinetic energy due to its own weight, the process of lowering the load or unwinding the corresponding cable must be braked in a controlled manner.

### SUMMARY

Braking is usually achieved by converting the potential energy of the load into heat when it is lowered. Solutions are known from the prior art in which the braking power required to lower the load is converted into heat by hydraulic devices. This can be done by selectively activating hydraulic consumers such as a hydraulic fan drive. Hydraulic brakes with one or more brake pumps specially designed for the braking process are usually used. The brake pumps can be supplied with large hydraulic flow rates via corresponding pressure stages in order to generate the required braking power. The braking energy absorbed by the brake pumps is converted into heat at the pressure stages, which heats up the hydraulic oil. This heat must be dissipated via hydraulic coolers or fans. For this purpose, the fans run at high speed, which generates a considerable noise level.

In addition, the torque balance between cable winches or hoists and brake pumps in these solutions is typically designed so that the winch motor must always deliver a positive torque. This principle enables good to very good control quality with little effort, but requires fuel consumption in lowering mode.

The present disclosure therefore addresses the problem of overcoming the above-mentioned disadvantages and enabling controlled, braked lowering of loads with reduced noise pollution and lower fuel consumption in generic work machines.

According to the disclosure, this object is achieved by a work machine as described herein.

Accordingly, according to a first aspect of the present disclosure, a work machine is proposed which comprises a cable winch, a motor driving the cable winch and a controller for controlling the motor. The controller can comprise several control units or control devices communicatively connected to one another or can be a single control unit. In principle, the work machine can be mobile (e.g. as a crawler crane, rail crane or mobile crane) or stationary (e.g. as a tower crane or harbor crane).

A cable for lifting and lowering a load is mounted on the cable winch so that it can be wound up and unwound. The term “load” is to be understood broadly here and can refer to an external load that can be attached to a load handling device (e.g. a hoist block) or a component of the work machine, such as a pivotably mounted boom or bracing frame. In the former case, the cable winch is in particular a hoist rope winch and the cable is a hoist rope. In the latter case, the cable winch can be an adjusting winch, which can be part of a bracing cabling for moving the component.

In particular, the motor is an internal combustion engine, for example a diesel motor. In addition to driving the cable winch, the motor can also serve as a traction drive for propelling the work machine. The motor comprises a braking device for generating a braking torque that counteracts an externally generated torque, which can also be referred to as a motor brake. In particular, the braking device can be actively actuated, for example by actuating a corresponding switching element in a driver's cab of the work machine. The braking device can be actuated or controlled by a controller. In the present case, the term “control” can denote both open-loop and closed-loop control (comprising a target/actual comparison).

The internal combustion engine could also be replaced by an electric motor. In this case, the braking device would have to be replaced with an equivalent. This replacement could be an electrical resistor, for example.

According to the disclosure, when the load is lowered or the cable is unwound from the cable winch, the controller is configured to actuate (i.e. to control by way of open-loop and/or closed-loop control) the braking device of the motor in dependence on a predetermined target braking torque and a braking torque that can actually be provided by the motor and to control the motor in such a way that the load is lowered at a predetermined and, in particular, variable or constant speed (this corresponds to a predetermined and, in particular, constant speed of the cable winch). The controller determines the target braking torque from the available variables. In particular, it specifies this for the cable winch or a winch motor driving the cable winch.

A basic concept of the present disclosure is therefore to use the motor brake of the motor to decelerate the load, wherein the motor is controlled for this purpose in such a way that a predetermined lowering speed of the load results. Since most of the motors installed in conventional work machines are already designed as internal combustion engines with a motor brake (which are, however, used to brake a travelling movement), no complex retrofitting of existing machines is necessary.

By using the motor brake to control a reduced speed of the cable winch or load, the use of hydraulic brakes can be completely or largely dispensed with. This can significantly reduce the noise development of the entire device, as the noisy fans for cooling the hydraulic oil are not required. Furthermore, conventional motor brakes are genuine continuous brakes that can be used over a very long period of time without any reduction in braking power due to high oil temperatures.

Using the motor brake to slow down the load also offers further advantages. This results in a reduction of the thermal load resulting from hot exhaust air from the fans in the entire motor compartment. In particular, the energy is converted via compression and/or decompression work and leaves the motor via an exhaust system instead of via hydraulic coolers. Furthermore, there is a reduction in the thermal load in the hydraulic system due to reduced hydraulic braking power, as the braking energy is not converted into heat via the hydraulic system. Lastly, the use of the motor brake in lowering mode leads to a reduction in fuel consumption, as the motor reaches the desired motor speed with no or only minimal injection.

In one possible embodiment, it is envisaged that the motor is an internal combustion engine, for example a spark ignition engine or preferably a diesel engine. The motor's braking device can comprise an air vane arranged in an exhaust duct of the motor and/or a throttle valve arranged in an intake duct of the motor. The corresponding valve is closed further to increase the braking torque. Alternatively or additionally, the motor may comprise a decompression brake (also known as “Jacob's brake” or “Jake brake” in English-speaking countries). In particular, the braking device can be a familiar motor brake used in conventional internal combustion engines. Preferably, the motor also serves as a drive for the work machine, wherein the braking device, in addition to its function according to the disclosure for braking the lowering speed of the load, can also be used in a known manner to decelerate the travelling speed.

In a further possible embodiment, it is provided that the controller is configured to determine the target braking torque at least on the basis of a detected current load, a current reeving of the cable, a desired lowering speed of the load and/or a desired rotational speed, for example a desired rotational speed of the cable winch and/or the motor. The current load can be detected by means of a detection device of the work machine and made available to the controller. For this purpose, the detection device can comprise one or more sensors in order to determine the current load. The higher the load detected, the greater the target braking torque must be in order to achieve a certain lowering speed. A current reeving of the cable (e.g. a hoist cable in a hoist winch or a guy cable in an adjusting winch) can also be detected via sensors or manually preset by the operator of the work machine via an input means. A desired lowering speed or a desired rotational speed can be determined automatically by the controller using other parameters and/or can be preset manually by the operator of the work machine using an input means (e.g. a master switch).

Alternatively or additionally, the controller can be configured to determine the braking torque that can actually be provided by the motor, at least on the basis of a detected current speed of the motor (i.e. the braking torque that can be provided can be speed-dependent). The braking torque that can be provided can depend on the properties and design of the braking device and/or the motor.

In a further possible embodiment, it is provided that the controller is configured to control a rotational speed, in particular the speed of the motor or the rotational speed of a winch motor driving the cable winch, to a target speed when the load is lowered in order to provide the target braking torque. In addition to influencing (i.e. controlling by way of open-loop and/or closed-loop control) the braking device, the control of the motor speed resulting from an externally generated torque can also include active control of the motor via at least one further motor parameter, for example fuel injection to generate an active motor torque that counteracts the braking torque generated by the braking device. This can result in improved control accuracy of the motor speed and thus the lowering speed of the load.

The target speed can refer to a speed of the motor. However, the target speed can also refer to a rotational speed of the cable winch (or a winch motor driving the cable winch) (i.e. the winch speed is controlled). This can be identical to the speed of the motor or different from it (e.g. because the cable winch is coupled to the motor via a gearing and/or a hydraulic circuit). It is also conceivable that the relevant control variable for the control circuit is the speed of the motor and that the target speed is converted from a desired winch rotational speed into a corresponding motor speed. In general, a winch motor speed can be converted into a motor speed and vice versa, as these are linked via the properties of the interposed components such as a gearing. It should be noted at this juncture that the motor with the braking device is always meant when just the term “motor” or “motor speed” is used.

In a further possible embodiment, it is provided that the motor is an internal combustion engine with fuel injection and the controller is configured to control, in an open-loop and/or closed-loop manner, the braking device in such a way that the braking torque resulting from the braking device is greater than the target braking torque. In other words, the controller specifically requests more braking torque from the motor than is required to achieve the specified lowering speed. This causes the actual speed of the motor to fall below a target speed. In order to compensate for this effect, the controller is configured to activate the fuel injection and control it in such a way that the higher braking torque of the braking device (or the reduction in motor speed) is equalized and the target torque on the motor or the target braking torque on the cable winch is set. The required braking torque is preferably only slightly higher than the required value, so that only small injection quantities are required for equalization. However, even such small injection quantities are sufficient to ensure cooling of the fuel injectors located in the combustion chamber of the internal combustion engine.

By activating the injection, a significantly higher control accuracy can be achieved in relation to the motor speed and thus an improved stability of the entire control loop. This can make a significant contribution to the stability of the overall system, especially with longer signal transmission cycle times (request, feedback, e.g. by means of CAN bus). Without injection, the overall system, the winch speed and therefore also the load could oscillate.

In a further possible embodiment, it is provided that the work machine comprises a hydraulic braking device for braking the cable winch or the load, which can be activated by the controller as required instead of or parallel to the braking device of the motor to generate the braking torque for lowering the load. The hydraulic braking device is used to convert energy into heat, whereby a braking torque is generated for the motor (i.e. the motor 16) or the cable winch connected to the hydraulic braking device.

The hydraulic braking device comprises at least one hydraulic brake with a hydraulic pump (brake pump) and, in particular, at least one pressure relief valve that acts as a pressure stage, through which hydraulic oil flows and which converts the braking energy absorbed by the brake pump into heat. The pressure relief valve can be actively controlled in order to adjust the braking torque. The hydraulic oil, which heats up as a result, must be cooled when a certain temperature is exceeded. For this purpose, the hydraulic braking device preferably comprises at least one hydraulically operated cooling device. This can comprise a hydraulic pump (additional brake pump) and a hydraulic fan motor, which may also be used to generate a braking torque and are therefore part of the hydraulic braking device.

In a further possible embodiment, it is provided that the controller is configured to brake a lowering of the load in a first braking phase completely or partially via the hydraulic braking device and, in a subsequent second braking phase, to reduce the braking torque transmitted to the cable winch by the hydraulic braking device continuously or in steps, while the braking torque transmitted to the cable winch by the braking device of the motor is increased continuously or in steps. Preferably, the controller is configured to keep the lowering speed of the load or a motor speed constant during the transfer of the braking torque from the hydraulic braking device to the braking device of the motor.

In this variant, braking, i.e. the control to a target speed, is initially performed via the hydraulic braking device, in particular exclusively (i.e. the motor's braking device is inactive). Then, preferably as soon as the speed has stabilized, the braking torque is successively transmitted from the hydraulic braking device to the motor's braking device. In a third braking phase, the braking torque is preferably provided exclusively by the motor's braking device, wherein the hydraulic braking device may only be activated temporarily in the case of load events in which the detected current load exceeds a defined limit value (interception of speed outliers) or in the case of a failure of the motor's braking device. Preferably, the first braking phase is short enough (e.g. less than twenty, preferably less than ten seconds) that the hydraulic oil does not heat up to such an extent that it would be necessary to activate a fan. This avoids the noise pollution caused by fan operation.

In an alternative possible embodiment, it is provided that the braking device of the motor takes over the braking torque for braking the load lowering right from the start, in particular exclusively (i.e. the hydraulic braking device of the motor is inactive from the start). In this variant, too, the hydraulic braking device can be switched on temporarily in the case of load events in which the detected current load exceeds a defined limit value and/or can be kept ready as a backup for a failure of the motor brake.

In another possible embodiment, the cable winch is connected to the motor via a transfer case. The hydraulic braking device described above can be connected to the transfer case so that one or more brake pumps can be driven by the motor. Preferably, all brake components of the work machine that can be used to brake a load-lowering speed are coupled or can be coupled to the motor via the transfer case.

Preferably, a closed hydraulic circuit is connected between the transfer case and the cable winch. In particular, the closed hydraulic circuit comprises a hydraulic pump that can be driven by the motor via the transfer case and a hydraulic winch motor.

In a further possible embodiment, it is provided that the work machine comprises a detection device connected to the controller for detecting a current rotational speed, in particular a current rotational speed of the motor and/or a winch motor, and/or for detecting a current load and/or for detecting a current torque (e.g. acting on the cable winch or on the winch motor). The detection device can comprise one or more sensors for detecting the aforementioned variables.

In a further possible embodiment, the work machine is designed as a mobile crane with a boom (e.g. lattice boom or telescopic boom) and a hoist rope guided over a boom head. The hoist rope carries a load suspension device (e.g. a hoist block) to which a load to be lifted can be attached. The cable winch, which can be braked via the motor brake, can be the hoist rope winch carrying the hoist rope. It is also conceivable that the crane comprises a boom or bracing frame (e.g. A-frame or derrick boom) that can be luffed using an adjusting winch and a corresponding cabling and that the cable winch that can be braked using the motor brake is an adjusting winch. The crane can comprise a mobile undercarriage and a superstructure with boom mounted rotatably on the undercarriage. The controller can be a crane controller (or comprise one).

In another possible embodiment, communication or signal transmission between the controller and the motor or braking device (and, if provided, between several control units of the controller) takes place via a bus, in particular a CAN bus. All relevant control variables and signals are exchanged via this bus.

According to a second aspect, the present disclosure relates to a method for lowering a load by means of a work machine according to the disclosure. Here, as already described in relation to the work machine according to the disclosure, the controller controls the motor by controlling the braking device in dependence on a target braking torque and a braking torque that can actually be provided by the motor, in such a way that the load is lowered at a predetermined and, in particular, constant speed. The control is preferably carried out in relation to a speed, in particular a speed of the motor or a winch motor. This results in the same advantages, properties and variants as already described in relation to the work machine according to the disclosure, so that a repetitive description is largely dispensed with.

In one possible embodiment, the motor is an internal combustion engine with fuel injection and the controller provides open-loop and/or closed-loop control of the braking device in such a way that the braking torque resulting from the braking device is greater than the target braking torque. In this case, the controller controls the speed of the motor via the fuel injection in such a way that the higher braking torque of the braking device is equalized and, in particular, the target braking torque is set at the cable winch.

In a further possible embodiment, it is provided that the work machine comprises a hydraulic braking device for braking the cable winch, wherein the controller brakes a lowering of the load directly (i.e. without first using the hydraulic braking device) via the braking device of the motor and the hydraulic braking device is only switched on in the event of certain load events or a failure of the motor brake.

In an alternative possible embodiment, it is provided that the work machine comprises a hydraulic braking device for braking the cable winch, wherein the controller brakes a lowering of the load in a first braking phase completely or partially via the hydraulic braking device, wherein, in a subsequent second braking phase, the controller continuously or gradually reduces the braking torque transmitted to the cable winch by the hydraulic braking device and simultaneously continuously or gradually increases the braking torque transmitted to the cable winch by the braking device of the motor, wherein the lowering speed of the load is preferably kept constant during the transfer of the braking torque from the hydraulic braking device to the braking device of the motor. This variant therefore involves a gradual transfer of the braking torque from the hydraulic braking device to the motor brake. The transfer can take place, for example, as soon as the speed has stabilized when lowering the load, wherein the controller can calculate a required braking torque from a detected load, a reeving, a desired load lowering speed and/or a desired winch speed for lowering.

The disclosure also relates to a computer program product which comprises instructions which, when the program is executed, in particular by said controller, cause the work machine according to the disclosure to carry out the steps of the method according to the disclosure. Of course, this only concerns the steps that can be carried out automatically and in particular by the controller, as described above. This results in the same advantages, properties and embodiments as already described in relation to the work machine according to the disclosure, so that a repetitive description is dispensed with.

Further applications for the solution according to the disclosure are conceivable. These would be: adjusting winches on the boom or a travelling drive on the crawler chassis.

### BRIEF DESCRIPTION OF THE FIGURES

Further features, details and advantages of the disclosure can be seen from the exemplary embodiments explained below with reference to the figures, in which:

FIG. 1: shows a schematic side view of the work machine according to the disclosure according to one exemplary embodiment; and

FIG. 2: shows a flow diagram of an exemplary embodiment of the method according to the disclosure for lowering a load.

### DETAILED DESCRIPTION

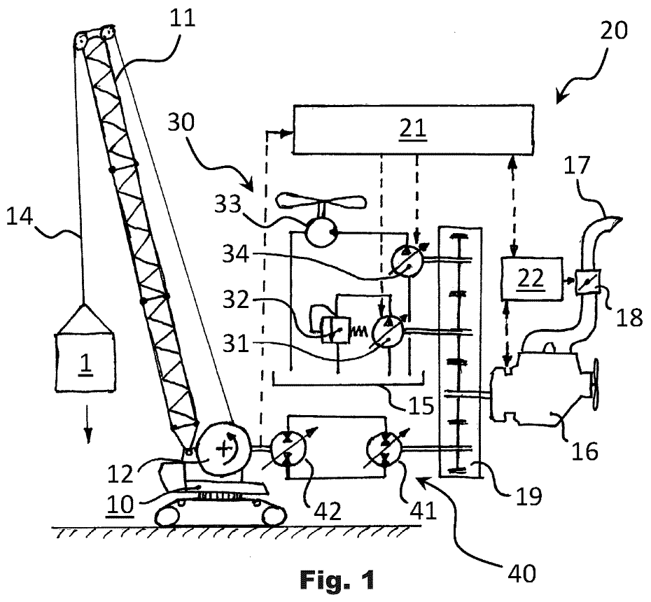

FIG. 1 shows a schematic representation of a preferred exemplary embodiment of the work machine 10 according to the disclosure, which in this example is designed as a crawler crane with a mobile undercarriage and an upper carriage mounted rotatably thereon. However, the following explanations with regard to the motor control apply to any embodiment of the work machine 10 and are not limited to this example.

The crawler crane 10 has a boom 11, which is pivotably mounted on the superstructure. The boom can be luffed up and down via a bracing cabling (not shown) and actuation of an adjusting winch (not shown). A cable 14 (hoist rope) is mounted on a cable winch 12 (hoist rope winch) arranged on the superstructure so that it can be wound up and unwound and carries a load suspension means to which a load 1 is attached. The load 1 can be raised or lowered by winding and unwinding the hoist rope 14.

The cable winch 12 is driven via a closed hydraulic circuit 40, which is connected to a motor 16 via a mechanical transfer case 19. The motor 16, which is designed as an internal combustion engine, drives a hydraulic pump 41 of the closed hydraulic circuit 40 via the transfer case 19, which in turn drives a hydraulic motor 42 acting as a winch motor.

The hydraulic pump 41 and/or the hydraulic motor 42 are adjusted accordingly via a desired specification by the operator for lowering the load, for example via a master switch, so that the load 1 is lowered by unwinding the hoist cable 14 from the cable winch 12. The pump 41 and/or motor 42 are controlled via a controller 20, which is described in greater detail below.

As in the exemplary embodiment shown in FIG. 1, the work machine 10 can comprise a hydraulic braking device 30, which is also coupled to the motor 16 via the transfer case 19 and can be driven by the latter. The hydraulic braking device 30 can comprise a hydraulic brake with a hydraulic pump 31 (brake pump) that can be driven by the motor 16 and a pressure relief valve 32 as a pressure stage.

In order to limit the speed of the load 1 when the load 1 is lowered, a braking torque that acts on the winch motor 42 or the cable winch 12 and reduces the lowering speed can be generated by activating the hydraulic braking device 30. For this purpose, the brake pump 31 is controlled by the control unit 21 in such a way that a volume flow is produced through the pressure relief valve 32, which generates the braking power. The pressure relief valve 32 can also be controlled by the control unit 21. As the hydraulic oil heats up during prolonged operation of the hydraulic brake, it must be cooled by a cooling device. In the exemplary embodiment shown in FIG. 1, the hydraulic brake device 30 comprises a fan with hydraulic motor 33 for this purpose, which is supplied with hydraulic oil via a further hydraulic pump 34. The hydraulic oil for the hydraulic braking device 30 is taken from a hydraulic tank 15 (open hydraulic circuit).

The motor 16 has a braking device 18 (hereinafter also referred to as a motor brake) to counteract an externally imposed torque (for example, generated by a gravity-driven lowering of the load 1, which exerts a torque on the motor 16 via the cable winch 12, the hydraulic circuit 40 and the transfer case 19). As in the exemplary embodiment in FIG. 1, the motor 16 can be designed as a diesel motor with an exhaust duct 17 in which an air vane 18 is arranged as a braking device. Alternatively or additionally, a throttle valve could also be provided in an inlet duct of a spark ignition engine, or a decompression brake could also be provided.

In particular, the motor 16 also serves as a drive motor for driving the crawler tracks of the crawler crane 10.

In accordance with the disclosure, the hydraulic braking device 30 is not (or at least not exclusively) used to brake the load 1 during a lowering process, but the motor brake 18 is used instead. To provide the required braking torque, the speed of the winch motor 42 is controlled by a controller 20 of the work machine 10. In the exemplary embodiment shown, the controller 20 comprises a first control unit 21, which controls the brake pumps 31, 34 and receives various sensor signals, and a second control unit 22, which controls the motor and the braking device 18 and is connected to the first control unit 21 (in FIG. 1, signal and control connections are shown as dashed lines). The second control unit 22 can be a motor control unit and thus part of the motor 16. Instead of two control units 21, 22, there may be three or more control units or even just a single control unit, which also controls the motor 16 and braking device 18.

The controller 20 determines a target braking torque for the cable winch 12 from the detected load, any reeving of the hoist cable 14 to be considered, and a target speed for the cable winch 12 (or the winch motor 42). This results in a predetermined and, in particular, constant speed of the load 1 during controlled lowering. In addition, a currently available, speed-dependent braking torque of the motor brake 18 is determined. According to one embodiment, the available braking torque is determined by the second control unit 22 and transmitted to the first control unit 21, wherein the actual control is performed by the first control unit 21.

According to a first variant, the braking torque for lowering the load 1 is provided from the start by the motor brake 18. The controller 20 establishes a torque balance from the available motor braking torque, which depends on the current speed of the motor 16, and the target braking torque for the cable winch 12, which depends on the load 1 to be lowered. The braking power then results from the current speed of the motor 16 or from the speed at which the load 1 is lowered (cable winch 12).

According to a second variant, the braking torque for a controlled lowering of the load 1 is initially provided via the hydraulic braking device 30, wherein the fan remains deactivated in this first braking phase, and is gradually transferred to the motor brake 18 after a short time (e.g. a few seconds). The transfer can take place after the speed of the winch motor 42 has stabilized.

Since the hydraulic braking device 30 is not used to brake the load 1 (or only after a short adjustment time), there is no need for noise-intensive cooling of the hydraulic oil. However, the hydraulic braking device 30 can be activated briefly to intercept speed deviations (position jump), but is substantially only used for safety purposes. Furthermore, the hydraulic braking device 30 can serve as a safety brake in the event of a failure of the motor brake 18 and/or as an auxiliary brake for braking in the event that the motor brake 18 cannot provide sufficient braking torque.

According to a preferred embodiment (which can apply to both variants mentioned), the motor 16 is an internal combustion engine with fuel injection and the overall system is tuned in such a way that when the braking torque is fully transferred to the motor brake 18, the controller 20 requests minimally more braking torque from the motor brake 18 than would be necessary to reach the target braking torque. The actual speed of the motor 16 falls below the target speed as a result of the high braking torque requirement. The injection in motor 16 is then activated. This results in a negative speed deviation from the target speed on the motor 16, so that the higher braking torque of the motor brake 18 is equalized and the desired braking torque or speed is set on the winch motor 42. By activating the injection, a significantly higher control accuracy (motor speed and thus stability of the entire control loop) can be achieved. As a rule, only very small injection quantities are required to equalize the speed deviation. However, these are sufficient to ensure cooling of the fuel injectors located in the combustion chamber of the motor 16.

The relevant control variables and signals are preferably exchanged between the components to be subjected to open-loop and/or closed-loop control and the controller 20 via a CAN bus (dashed lines in FIG. 1).

The use of the motor brake 16 according to the disclosure is not only applicable for hoisting winches, as shown in FIG. 1, but also for other applications with regenerative operation (e.g. for adjusting winches for moving booms, etc.).

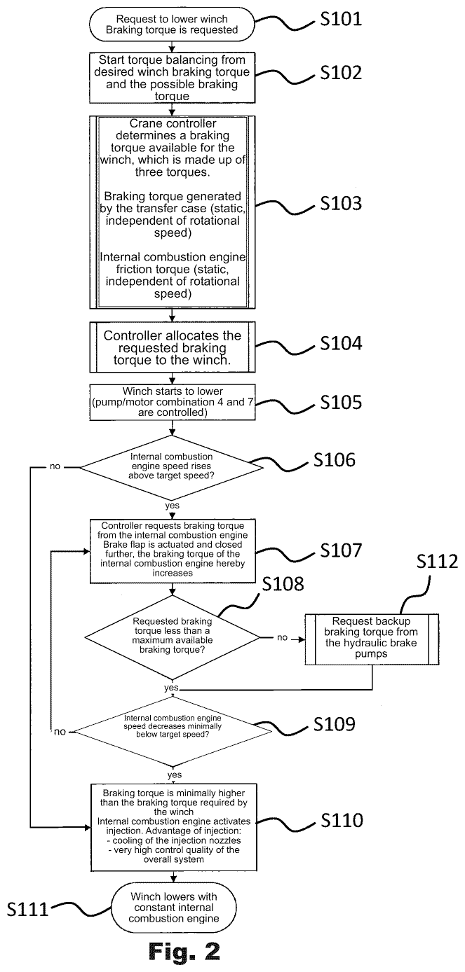

FIG. 2 shows a flow diagram of an exemplary embodiment of the method according to the disclosure. In particular, the corresponding steps are carried out by the controller 20 (apart from any operator input).

In step S101, a lowering of the load 1 is requested, for example via a corresponding input from the operator using a master switch. A target braking torque for the cable winch 12 is requested for the controlled, braked lowering of the load 1.

In the subsequent step 102, the torque balancing is initiated from the desired target braking torque for the cable winch 12 and the braking torque actually available through the braking device 18 of the motor 16.

In the following step 103, the torque is balanced. For this purpose, the controller 20 determines a braking torque available for the cable winch 12, which is made up of three torques: the braking torque generated by the transfer case 19 (static and independent of the rotational speed), the combustion engine friction torque (static and independent of the rotational speed) and the braking torque supplied by the braking device 18 of the motor 16 (which can be a brake flap, for example) (variable, as it depends on the motor speed).

In the following step 104, the controller 20 allocates the requested braking torque to the cable winch 12.

In the subsequent step 105, the cable winch 12 is controlled (by corresponding control of the motor 16, which drives the cable winch 12 via the closed hydraulic circuit 40) so that the load 1 begins to lower.

In the following step 106, the controller 20 checks whether the speed of the motor 16 is above a target speed. If not, it goes directly to step S110 (see below). If yes, the system proceeds to step S107.

In step S107, the controller 20 requests a braking torque from the motor 16 or from the braking device 18. The braking device 18 is actuated (in one exemplary embodiment, this is a brake flap that is closed further) in such a way that the braking torque supplied by the motor 16 increases.

In the subsequent step 108, the controller 20 checks whether the requested braking torque is less than a maximum available braking torque (which depends, among other things, on the speed and the characteristics of the braking device 18).

If this is not the case, i.e. if the requested braking torque is greater than the maximum available braking torque, the braking torque required for braking cannot be provided by the motor 16 (or the motor brake 18) alone. Therefore, in a step S122, the hydraulic braking device 30 is activated and the total braking torque provided to the cable winch 12 is thereby increased so that the target braking torque is reached.

If the requested braking torque is less than the maximum available braking torque, step S109 is carried out. Here, the controller 20 checks whether the motor speed falls below a target speed due to the provision of the requested braking torque by the motor 16. If not, the system returns to step S107 (further increase in the requested braking torque). If yes, the system moves on to step S110, wherein the braking torque supplied by the motor 16 is now minimally higher than the braking torque required to achieve the target braking torque demanded for the cable winch 12.

In step S110, the controller 20 activates the injection of the motor 16. This actively increases the motor speed, which minimally reduces the braking torque on the internal combustion engine 16 in order to provide the cable winch 12 with the target braking torque.

Due to the control shown, the load 1 is lowered at a constant speed (or the cable winch 12 rotates at a constant motor speed). As used herein, a constant parameter, such as a speed, means that the variation is that of minor fluctuations inherent to a real world operating system. In an example, a constant speed is one that varies by less than 5%.

### LIST OF REFERENCE SIGNS

1 load
10 work machine
11 boom
12 cable winch
14 cable
15 hydraulic tank
16 motor
17 outlet duct
18 braking device (motor brake)
19 transfer case
20 controller
21 first control unit
22 second control unit
30 hydraulic braking device
31 brake pump
32 pressure relief valve
33 fan motor
34 hydraulic pump (brake pump)
40 closed hydraulic circuit
41 hydraulic pump
42 hydraulic motor (winch motor)

1. A work machine comprising a cable winch, by means of which a cable can be wound up for lifting a load and unwound for lowering the load, a motor, by means of which the cable winch can be driven, and a controller, by means of which the motor can be controlled, wherein the motor comprises a braking device for generating a braking torque counteracting an externally generated torque,
wherein
when the load is lowered as a function of a predetermined target braking torque and a braking torque that can be provided by the motor, the controller is configured to control the braking device and to control the motor in such a way that the load is lowered at a predetermined speed.

2. The work machine according to claim 1, wherein the motor is an internal combustion engine.

3. The work machine according to claim 1, wherein the controller is configured to determine the target braking torque at least on the basis of a detected current load, a current reeving of the cable, a desired lowering speed of the load and/or a desired rotational speed and/or to determine the braking torque that can be provided by the motor at least on the basis of a detected current rotational speed of the motor.

4. The work machine according to claim 1, wherein the controller is configured to control a rotational speed to a target rotational speed when the load is lowered, in order to provide the target braking torque for the cable winch.

5. The work machine according to claim 3, wherein the motor is an internal combustion engine with fuel injection and the controller is configured to provide open-loop and/or closed-loop control of the braking device such that the braking torque resulting from the braking device is greater than the target braking torque.

6. The work machine according to claim 1, further comprising a hydraulic braking device for braking the cable winch, which braking device can be activated by the controller as required instead of or parallel to the braking device of the motor for generating a braking torque on the cable winch, wherein the hydraulic braking device comprises at least one hydraulic brake with a hydraulic pump.

7. The work machine according to claim 6, wherein the controller is configured to brake a lowering of the load in a first braking phase via the hydraulic braking device and to reduce the braking torque transmitted to the cable winch by the hydraulic braking device in a subsequent second braking phase, while the braking torque transmitted to the cable winch by the braking device of the motor is increased.

8. The work machine according to claim 6, wherein the controller is configured to brake a lowering of the load via the braking device of the motor and to temporarily activate the hydraulic braking device only in the case of load events in which a detected current load exceeds a defined limit value.

9. The work machine according to claim 1, wherein the cable winch is connected to the motor via a transfer case.

10. The work machine according to claim 1, further comprising a detection device connected to the controller for detecting a current rotational speed and/or a current load and/or a current torque.

11. A method for lowering a load by means of a work machine according to claim 1, wherein the controller controls the motor by controlling the braking device in dependence on a desired braking torque and a braking torque providable by the motor, in such a way that the load is lowered at the predetermined constant speed.

12. The method according to claim 11, wherein the motor is an internal combustion engine with fuel injection and the controller provides open-loop and/or closed-loop control of the braking device in such a way that the braking torque resulting from the braking device is greater than the target braking torque, wherein the controller controls the speed of the motor via the fuel injection in such a way that the higher braking torque of the braking device is equalized and the target braking torque is set.

13. The method according to claim 11, wherein the work machine comprises a hydraulic braking device for braking the cable winch, wherein the controller brakes a lowering of the load via the braking device of the motor and temporarily activates the hydraulic braking device only in the case of load events in which a detected current load exceeds a defined limit value.

14. The method according to claim 11, wherein the work machine comprises a hydraulic braking device for braking the cable winch, wherein the controller brakes a lowering of the load in a first braking phase via the hydraulic braking device, wherein, in a subsequent second braking phase, the controller reduces the braking torque transmitted to the cable winch by the hydraulic braking device and simultaneously increases the braking torque transmitted to the cable winch by the braking device of the motor, wherein the lowering speed of the load is kept constant during the transmission of the braking torque from the hydraulic braking device to the braking device of the motor.

15. The work machine according to claim 1, wherein the work machine is a crane.

16. The work machine according to claim 1, wherein the predetermined speed is a constant speed.

17. The work machine according to claim 2, wherein the braking device of the motor comprises an air vane arranged in an exhaust duct and/or a throttle valve arranged in an intake duct and/or a decompression brake.

18. The work machine according to claim 4, wherein the controller is configured to provide open-loop and/or closed-loop control of the braking device and to control the rotational speed of the motor via at least a fuel injection system.

19. The work machine according to claim 5, wherein the controller is also configured to control a rotational speed of the motor, via the fuel injection such that the higher braking torque of the braking device is equalized and the target braking torque is set at the cable winch.

20. The work machine according to claim 9, wherein the cable winch is connected to the motor via a transfer case and can be driven via a closed hydraulic circuit connected between the transfer case and the cable winch, wherein a hydraulic braking device is connected to the transfer case.
